(19) United States
(12) Patent Application Publication
(10) Pub. No.: US 2015/0346389 A1
(43) Pub. Date: Dec. 3, 2015

(54) Polarizer Protecting Film, Method for Production Thereof, Polarizing Plate, Optical Film, and Image Display Device

(71) Applicant: Nitto Denko Corporation, Ibaraki-shi, Osaka (JP)

(72) Inventors: Midori ASANO, Ibaraki-shi, Osaka (JP); Reiko AKARI, Ibaraki-shi, Osaka (JP); Yuuji SAIKI, Ibaraki-shi, Osaka (JP)

(21) Appl. No.: 14/418,822

(22) PCT Filed: May 29, 2014
(86) PCT No.: PCT/JP2014/064303

§ 371 Date: Jan. 30, 2015

(30) Foreign Application Priority Data
Jun. 28, 2013 (JP) 2013-136912
May 8, 2014 (JP) 2014-096746

(51) Int. Cl. G02B 1/14; B32B 17/06; B32B 27/32; B32B 27/30; G02B 5/30; B32B 7/12

(52) U.S. Cl. CPC G02B 1/14; G02B 5/3033; B32B 7/12; B32B 27/325; B32B 27/308; B32B 17/064; B32B 2255/10; B32B 2255/24; B32B 2307/412; B32B 2307/42; B32B 2307/558; B32B 2307/5825; B32B 2457/20

(57) ABSTRACT

Provided is a polarizer protecting film that can have good adhesion to a polarizer when bonded to the polarizer with an adhesive layer interposed therebetween. The polarizer protecting film includes a transparent thermoplastic resin film and a modification layer or layers that are provided on one or both sides of the transparent thermoplastic resin film and include at least one solvent selected from an alicyclic ether and an alicyclic alcohol.

### TECHNICAL FIELD

The invention relates to a polarizer protecting film and a method for production thereof. The invention also relates to a polarizing plate produced with the polarizer protecting film. The polarizing plate can be used alone or as a component of a multilayer optical film to form an image display device such as a liquid crystal display (LCD), an organic electroluminescent (EL) display, a cathode ray tube (CRT), or a plasma display panel (PDP).

### BACKGROUND ART

Liquid crystal display devices are used in personal computers, televisions, monitors, cellular phones, personal digital assistants (PDAs), and other devices. Polarizers conventionally used in liquid crystal display devices are dyed polyvinyl alcohol films, which have a high level of transmittance and polarization degree. Such polarizers are manufactured by a process including subjecting a polyvinyl alcohol film to each of treatments such as swelling, dyeing, crosslinking, and stretching in baths, then cleaning it, and drying it. Such polarizers are generally used in the form of polarizing plates, which include a polarizer and a protective film or films bonded to one or both sides of the polarizer with an adhesive.

Unfortunately, when a cycloolefin resin film or an acrylic resin film is used as an optical film (thermoplastic resin film) to form a polarizer protecting film, the polarizer protecting film is not always bonded with sufficient adhering strength to a polarizer. To solve this problem, it is proposed to modify the surface of the cycloolefin or acrylic resin film with a solvent so that its adhesion can be improved (Patent Documents 1 and 2).

### PRIOR ART DOCUMENTS

### Patent Documents

Patent Document 1: JP-A-2012-177890

Patent Document 2: JP-B1-4849665

### SUMMARY OF THE INVENTION

### Problems to be Solved by the Invention

Patent Document 1 discloses the use of an alicyclic hydrocarbon as a surface-modifying solvent. Patent Document 2 shows examples of surface-modifying solvents, which include ketones, esters, ethers, polyhydric alcohol esters, furans, acids, halogenated hydrocarbons, nitrogen compounds, and sulfonic acids. However, the solvents disclosed in Patent Documents 1 and 2 do not sufficiently improve the cohesive strength between the adhesive layer and the polarizer protecting film, and when a polarizing plate is obtained by bonding the polarizer and the polarizer protecting film together with an adhesive layer, the adhering strength (peel strength) is not sufficient in the polarizing plate.

In recent years, as liquid crystal display devices are made thinner, polarizing plates are required to be thinner, and polarizer protecting films are also required to be thinner. In some cases, a retardation film is used as a polarizer protecting film. In order to allow a polarizer protecting film to have both small thickness and retardation properties, a thin, highly-stretched optical film (thermoplastic resin film) is required to be used to form the polarizer protecting film. However, such a thin and highly-stretched film has a fragile layer in the vicinity of its surface, where the orientation is higher than that in the central part of the film, because it has undergone high-ratio stretching for achieving both small thickness and retardation properties. Therefore, when a retardation film is used as a polarizer protecting film, improvement of cohesive strength is particularly desired because its impact resistance or tear strength is reduced especially in the vicinity of its surface.

It is an object of the invention to provide a polarizer protecting film that can have good adhesion to a polarizer when bonded to the polarizer with an adhesive layer interposed therebetween and to provide a method for producing such a polarizer protecting film. It is another object of the invention to provide a polarizing plate that includes a polarizer and the polarizer protecting film bonded together with an adhesive layer and has good adhesion between them.

It is a further object of the invention to provide an optical film including such a polarizing plate. It is a further object of the invention to provide an image display device produced with such a polarizing plate or optical film.

### Means for Solving the Problems

As a result of diligent studies for solving the problems, the inventors have accomplished the invention based on findings that the objects can be achieved by the polarizer protecting film and other techniques described below.

Specifically, the invention relates to a polarizer protecting film, including: a transparent thermoplastic resin film; and a modification layer that is provided on one or both sides of the transparent thermoplastic resin film and include at least one modification solvent (a) selected from an alicyclic ether and an alicyclic alcohol, the polarizer protecting film having a haze of 0.5 to 7%.

The polarizer protecting film is advantageous when the transparent thermoplastic resin film includes at least one selected from a cyclic polyolefin resin and a (meth)acrylic resin.

In the polarizer protecting film, the modification layer preferably has a thickness of 50 to 600 nm.

The polarizer protecting film preferably has a thickness of 5 to 100 μm.

The polarizer protecting film can be advantageously used also when the transparent thermoplastic resin film is a retardation film.

The invention also relates to a method for producing the polarizer protecting film, the method including subjecting one or both sides of a transparent thermoplastic resin film to a surface treatment by bringing a solvent (A) into contact with one or both sides of the transparent thermoplastic resin film to form a modification layer or layers on one or both sides, wherein the solvent (A) includes at least one modification solvent (a) selected from an alicyclic ether and an alicyclic alcohol.

In the method for producing the polarizer protecting film, the solvent (A) preferably contains a solvent (b) that is mixed with the modification solvent (a) and has substantially no effect on the transparent thermoplastic resin film.

In the method for producing the polarizer protecting film, the ratio of the modification solvent (a) to the solvent (b) is preferably 10:90 to 50:50 by volume.

The invention also relates to a polarizing plate including: a polarizer; an adhesive layer; and the polarizer protecting film provided on at least one surface of the polarizer with the adhesive layer interposed therebetween, wherein the adhesive layer is in contact with the modification layer of the polarizer protecting film.

The invention also relates to an optical film including the polarizing plate.

The invention further relates to an image display device including the polarizing plate or the optical film.

### Effect of the Invention

The polarizer protecting film of the invention has a modification layer on its surface. The modification layer includes at least one modification solvent (a) selected from an alicyclic ether and an alicyclic alcohol. In other words, the polarizer protecting film of the invention has its surface modified with the modification solvent (a). The modified surface of the polarizer protecting film of the invention can have improved cohesive strength and improved adhering strength (peel strength) with respect to an adhesive layer used for bonding to a polarizer.

In some conventional cases where a retardation film is used to form a polarizer protecting film, an impact applied to the end of a polarizing plate produced with the polarizer protecting film causes delamination of a fragile layer from the polarizer protecting film. On the other hand, the polarizer protecting film of the invention has the modification solvent (a)-impregnated modification layer in the vicinity of its surface, so that the orientation is lowered and the cohesive strength is increased only in the vicinity of its surface, even when a retardation film is used to form the polarizer protecting film. In the polarizer protecting film of the invention, therefore, any fragile layer in the vicinity of its surface is modified to have improved cohesive strength even when a retardation film is used to form the polarizer protecting film, which makes it possible to provide a polarizing plate that does not cause delamination even in an impact resistance test or a tear test.

The modification solvent (a), which has a heat of vaporization lower than that of alicyclic hydrocarbon solvents, slowly undergoes drying after the modification of the surface of a polarizer protecting film (thermoplastic resin film), which is advantageous in that the thickness of the modification layer and uneven coating can be easily controlled.

### MODE FOR CARRYING OUT THE INVENTION

The polarizer protecting film of the invention includes a transparent thermoplastic resin film and a modification layer or layers that are provided on one or both sides of the transparent thermoplastic resin film and include at least one modification solvent (a) selected from an alicyclic ether and an alicyclic alcohol.

<Transparent Thermoplastic Resin Film>

The material used to form the polarizer protecting film is, for example, a thermoplastic rein having a high level of transparency, mechanical strength, thermal stability, water barrier properties, and isotropy. Examples of such a thermoplastic resin include a cellulose resin such as triacetylcellulose, a polyester resin, a polyethersulfone resin, a polysulfone resin, a polycarbonate resin, a polyamide resin, a polyimide resin, a polyolefin resin, a (meth)acrylic resin, a cyclic polyolefin resin (norbornene resin), a polyarylate resin, a polystyrene resin, a polyvinyl alcohol resin, and any mixture thereof.

The polarizer protecting film of the invention may contain an ultraviolet absorber and a common additive such as a stabilizer, a lubricant, a processing aid, a plasticizer, an impact resistant aid, a retardation reducing agent, a matting agent, an antimicrobial agent, or an antifungal agent.

Among the above thermoplastic resins, at least one selected from a cyclic polyolefin resin and a (meth)acrylic resin is preferably used to form the polarizer protecting film of the invention. In the invention, the polarizer protecting film has a modification layer. The modification layer has good adhesion to the various transparent protective films shown above. In particular, the modification layer according to the invention has good adhesion even to cyclic polyolefin resin and (meth)acrylic resin, where satisfactory adhesion has been difficult to achieve before.

For a specific example, the cyclic polyolefin resin is preferably a norbornene resin. Cyclic olefin resin is a generic name for resins produced by polymerization of cyclic olefin used as a polymerizable unit, and examples thereof include the resins disclosed in JP-A-01-240517, JP-A-03-14882, and JP-A-03-122137. Specific examples thereof include ring-opened (co)polymers of cyclic olefins, addition polymers of cyclic olefins, copolymers (typically random copolymers) of cyclic olefin and α-olefin such as ethylene or propylene, graft polymers produced by modification thereof with unsaturated carboxylic acids or derivatives thereof, and hydrides thereof. Specific examples of the cyclic olefin include norbornene monomers.

Cyclic polyolefin resins have various commercially available sources. Specific examples thereof include ZEONEX (trade name) and ZEONOR (trade name) series manufactured by ZEON CORPORATION, ARTON (trade name) series manufactured by JSF Corporation, TOPAS (trade name) series manufactured by Ticona, and APEL (trade name) series manufactured by Mitsui Chemicals, Inc.

The (meth)acrylic resin preferably has a glass transition temperature (Tg) of 115° C. or more, more preferably 120° C. or more, even more preferably 125° C. or more, still more preferably 130° C. or more. If the Tg is 115° C. or more, the resulting polarizing plate can have high durability. The upper limit to the Tg of the (meth)acrylic resin is preferably, but not limited to, 170° C. or less, in view of formability or the like. The (meth)acrylic resin can form a film with an in-plane retardation (Re) of almost zero and a thickness direction retardation (Rth) of almost zero.

Any appropriate (meth)acrylic resin may be used as long as the effects of the invention are not impaired. Examples of such a (meth)acrylic resin include poly(meth)acrylate such as poly(methyl methacrylate), methyl methacrylate-(meth)acrylic acid copolymers, methyl methacrylate-(meth)acrylic ester copolymers, methyl methacrylate-acrylic ester-(meth)acrylic acid copolymers, methyl (meth)acrylate-styrene copolymers (such as MS resins), and alicyclic hydrocarbon group-containing polymers (such as methyl methacrylate-cyclohexyl methacrylate copolymers and methyl methacrylate-norbornyl (meth)acrylate copolymers). Poly(C1 to C6 alkyl (meth)acrylate) such as poly(methyl (meth)acrylate) is preferred. A methyl methacrylate-based resin composed mainly of a methyl methacrylate unit (50 to 100% by weight, preferably 70 to 100% by weight) is more preferred.

Specific examples of the (meth)acrylic resin include ACRYPET VH and ACRYPET VRL20A each manufactured by MITSUBISHI RAYON CO., LTD., and the (meth)acrylic resins disclosed in JP-A-2004-70296 including (meth)acrylic resins having a ring structure in their molecule and high-Tg (meth)acrylic resins obtained by intramolecular crosslinking or intramolecular cyclization reaction.

Lactone ring structure-containing (meth)acrylic resins may also be used as the (meth)acrylic resin. This is because they have high heat resistance and high transparency and also have high mechanical strength after biaxially stretched.

Examples of the lactone ring structure-containing (meth)acrylic reins include the lactone ring structure-containing (meth)acrylic reins disclosed in JP-A-200-230016, JP-A-2001-151814, JP-A-2002-120326, JP-A-2002-254544, and JP-A-2005-146084.

A retardation film including the thermoplastic resin film may be used to form the polarizer protecting film of the invention. The retardation film may have an in-plane retardation of 40 nm or more and/or a thickness direction retardation of 80 nm or more. The in-plane retardation is generally adjusted to fall within the range of 40 to 200 nm, and the thickness direction retardation is generally adjusted to fall within the range of 80 to 300 nm. When a retardation film is used to form the polarizer protecting film, the retardation film can also serve as the polarizer protecting film, which contributes to thickness reduction.

The retardation film may be a birefringent film formed by subjecting a thermoplastic resin film to uniaxial or biaxial stretching. The stretching temperature, the stretch ratio, and other conditions may be appropriately determined depending on the retardation value, the film material, and the thickness.

The thickness of the polarizer protecting film may be determined as needed. Generally, the thickness of the polarizer protecting film is from about 1 to about 500 μm in view of strength, workability such as handleability, and thin layer formability. In particular, the thickness is preferably from 1 to 300 μm, more preferably from 5 to 200 μm. When the polarizer protecting film is of a thin type, its thickness is preferably from 5 to 150 μm, more preferably from 5 to 100 μm. When a retardation film is used to form the polarizer protecting film, it is preferably of a thin type with a thickness of 5 to 150 μm, more preferably 5 to 100 μm.

The polarizer protecting film of the invention has a modification layer or layers on its one or both sides. The modification layer or layers include at least one modification solvent (a) selected from an alicyclic ether and an alicyclic alcohol. The alicyclic ether and the alicyclic alcohol may be used alone independently or used as a mixture. The alicyclic ether and the alicyclic alcohol to be used are able to cause dissolving or swelling of the surface of the thermoplastic resin film for the polarizer protecting film.

The alicyclic ether is a compound having at least one alicyclic structure and an ether bond, such as cyclopentyl methyl ether (CPME), dicyclolomethyl ether, methyl cyclohexyl ether, butyl cyclohexyl ether, or dicyclopentyl ether. The alicyclic alcohol is a compound having at least one alicyclic structure and a hydroxyl group, such as cyclopentanol, cyclohexanol, or methylcyclohexanol. The modification solvent (a) is preferably an alicyclic ether, and cyclopentyl methyl ether (CPME) is particularly preferred.

The alicyclic ether and the alicyclic alcohol are also advantageous because their heat of vaporization is lower than that of toluene, xylene, and alicyclic hydrocarbons such as cyclohexane and ethylcyclohexane. The alicyclic ether and the alicyclic alcohol to be used preferably nave a heat of vaporization of 0 to 300 kJ/kg. Cyclopentyl methyl ether (CPME) has a heat of vaporization of 289 kJ/kg, toluene 363 kJ/kg, xylene 392 kJ/kg, and cyclohexane 394 kJ/kg.

The polarizer protecting film of the invention has a haze of 0.5 to 7%. The polarizer protecting film with a haze of 0.5% or more is considered to have a modification layer capable of improving cohesive strength (peel strength). On the other hand, if the haze exceeds 7%, transparency may be lost. From this viewpoint, the haze preferably has a lower limit of 0.6% or more, more preferably 0.7% or more, and preferably has an upper limit of 6.5% or less, more preferably 6% or less, even more preferably 5% or less. The haze (external haze) was measured with a haze meter (HGM-20P manufactured by Suga Test Instruments Co., Ltd.) according to JISK7136.

The modification layer preferably has a thickness of 50 to 600 nm. The modification layer with a thickness of 50 nm or more is thick enough to improve cohesive strength (peel strength). On the other hand, as the thickness of the modification layer increases, the polarizer protecting film may increase in haze and become more likely to lose transparency. When a retardation film is used to form the polarizer protecting film, an increase in the thickness of the modification layer can also cause a change in retardation on the surface of the polarizer protecting film (retardation film), which may affect optical properties when the polarizing plate is used in a liquid crystal display device. From this viewpoint, the thickness of the modification layer is preferably 600 nm or less. The thickness of the modification layer is more preferably from 100 to 500 nm, even more preferably from 200 to 400 nm. The thickness of the modification layer was determined from the difference in contrast observed in a transmission electron microscope (TEM) image.

The polarizer protecting film of the invention can be produced by bringing one or both sides of a transparent thermoplastic resin film into contact with a solvent (A) including at least one modification solvent (a) selected from an alicyclic ether and an alicyclic alcohol so that a modification layer or layers are formed on one or both sides. One or both sides of the transparent thermoplastic resin film is surface-treated with the solvent (A) including the modification solvent (a) so that a modification layer or layers including the modification solvent (a) are formed.

The solvent (A) to be brought into contact with the thermoplastic resin film preferably includes not only the modification solvent (a) but also a solvent (b) that is mixed with the modification solvent (a) and has substantially no effect on the transparent thermoplastic resin film. When the solvent (A) is only the modification solvent (a), excessive modification can easily occur, and the retardation may be reduced by the modification. However, when the solvent (A) contains both the modification solvent (a) and the solvent (b), the formation of the modification layer and the control of its thickness can be easily performed by the surf ace treatment. The solvent (b) that has substantially no effect on the transparent thermoplastic resin film refers to a solvent that does not cause the transparent thermoplastic resin film to be deformed (visual observation) or to increase in haze after about one drop of the solvent is placed on the film, allowed to stand at room temperature (2300) for 1 minute, and then wiped off.

The solvent (b) is preferably such that it can easily evaporate upon drying after the formation of the modification layer and specifically has a boiling point of 200° C. or lower. Examples of the solvent (b) include ketones such as acetone, methyl ethyl ketone, methyl isobutyl ketone, methyl-n-amyl ketone, cyclohexanone, diacetone alcohol, diisobutyl ketone, and methylcyclohexanone; water; alcohols such as isopropyl alcohol and ethanol; furans such as tetrahydrofuran and furfural; ethers such as diethyl ether, dioxolane, dioxane, methyl cellosolve, and methyl carbitol; acids such as acetic acid and glacial acetic acid; esters such as methyl acetate, ethyl acetate, ethyl lactate, butyl lactate, ethyl benzoate, and methyl acetoacetate; polyhydric alcohol esters such as methyl cellosolve acetate and cellosolve acetate; halogenated hydrocarbons such as methylene chloride, ethylene dichloride, and tetrachloroethane; nitrogen compounds such as nitromethane, nitroethane, pyridine, dimethylformamide, and nitrobenzene; and sulfonic acids such as dimethylsulfoxide. The solvent (b) is preferably a ketone, and acetone or methyl ethyl ketone is particularly preferred.

The solvent (b) should be appropriately selected depending on the material type of the thermoplastic resin film and the type of the modification solvent (a). When cyclopentyl methyl ether (CPME) is used as the modification solvent (a), the solvent (b) is preferably a ketone, more preferably acetone or methyl ethyl ketone. When the thermoplastic resin film is made of a cyclic polyolefin resin or a (meth)acrylic resin, the solvent (b) is preferably a ketone, more preferably acetone or methyl ethyl ketone.

The ratio (volume ratio) of the modification solvent (a) to the solvent (b) ((a):(b)) is preferably 10:90 to 50:50. The ratio (a):(b) is more preferably 10:90 to 40:60, even more preferably 10:90 to 30:70.

The solvent (A) may also be used in the form of a solution containing a primer component as a solute. Any primer material capable of improving the adhesion between the thermoplastic resin film and the polarizer may be used. The solution may contain 0.1% by weight or less of the primer component as long as the invention is not affected. The primer material may be, for example, a coupling agent. The coupling agent is a compound having a functional group that can be easily bonded to both the thermoplastic resin film and the polarizer, such as a silane coupling agent, a titanium coupling agent, or a zirconium coupling agent. In particular, a silane coupling agent is highly effective in improving tackiness.

The coupling agent may be, for example, but not limited to, a compound represented by formula (1): Y−R¹-M (X)ₙ(R²₃₋ₙ. In the formula, M is Si, Ti, Zr, or the like, preferably Si. The letter n is an integer of 1 to 3. X is a hydrolyzable group. For example, when M is Si, the hydrolyzable group is able to be converted to a silanol group (SiOH). X may be, for example, a chloro group, an alkoxy group (containing an organic group such as a methyl group, an ethyl group, or any other alkyl group), an acetoxy group, an amino group, or the like. In particular, an alkoxy group is preferred. R² is an alkyl group such as a methyl or ethyl group. Y is a functional group capable of reacting with organic materials, such as a vinyl group, an epoxy group, a (meth)acryl group, an amino group, or a mercapto group. R¹ is a single bond or an organic group containing an alkylene group of about 1 to 3 carbon atoms or the like.

Besides the above, an organic primer material may also be used. The organic primer may be any of various materials capable of improving the adhesion between the thermoplastic film and the polarizer. Preferably, the organic primer is a material having a functional group capable of forming a bond with a hydroxyl group, a carboxyl group, or other groups. Hydroxyl group-containing polymer materials include partially saponified polyvinyl acetate, polyvinyl alcohol, etc. Carboxyl group-containing polymer materials include polyacrylic acid, etc. Polymer materials having functional groups such as hydroxyl or carboxyl groups include the polymer materials shown above, acryl-based polymers having a component(s) derived from a carboxyl group-containing monomer and/or a hydroxyl group-containing monomer, epoxy resins, and polyester resins.

In the production of the polarizer protecting film of the invention, the solvent (A) can be brought into contact with one or both sides of the transparent thermoplastic resin film by a coating method, a dipping method, or other methods. When a coating method is used, the solvent (A) may be applied in any suitable amount as long as the effects of the invention are not impaired. Preferably, the solvent (A) is applied in an amount of 0.0001 to 1 ml, more preferably 0.001 to 0.1 ml per 1 cm² of the film surface.

The coating method may be casting, meyer bar coating, gravure coating, comma coating, doctor blade coating, die coating, dip coating, spraying, or any other known method.

The contact with the solvent (A) is appropriately followed by drying. The drying may be air drying or drying by heating. In order to prevent film deformation, drying by heating is preferably performed at a temperature not higher than the glass transition temperature of the thermoplastic resin film.

The polarizing plate of the invention includes a polarizer and the polarizer protecting film provided on at least one side of the polarizer with an adhesive layer interposed therebetween, wherein the adhesive layer is in contact with the modification layer of the polarizer protecting film.

Polarizer protecting films may be provided on both sides of the polarizer. In this case, the polarizer protecting films used on the front and back sides may be the same or different, but at least one of them is the polarizer protecting film having the modification layer. The other side of the polarizer, opposite to its side where the polarizer protecting film having the modification layer is provided, may be provided with another polarizer protecting film or a transparent protective film made of a thermosetting or ultraviolet-curable resin such as a (meth)acrylic, urethane, acrylic urethane, epoxy, or silicone resin.

One surface of the polarizer protecting film, to which no polarizer is bonded, may be subjected to a hard coating treatment, an antireflection treatment, an anti-sticking treatment, or a treatment for imparting diffusion or antiglare properties.

<Polarizer>

A polarizer used to form the polarizing plate of the invention is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. Among such polarizers, preferred is a polarizer composed of a polyvinyl alcohol type film and a dichroic substance such as iodine. Although thickness of polarizer is not especially limited, the thickness of about 1 to 80 μm is commonly adopted.

In the invention, the polarizer is preferably an iodine-based polarizer. The iodine-based polarizer includes a polyvinyl alcohol-based film and iodine adsorbed and oriented thereon. The iodine-based polarizer can be obtained, for example, by subjecting a polyvinyl alcohol-based film to at least dyeing, cross-linking, and stretching processes. The dyeing, crosslinking, and stretching processes are performed using dyeing, crosslinking, and stretching baths, respectively. Each treatment bath contains a treatment liquid (such as an aqueous solution) suitable for each process.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thin polarizer with a thickness of 10 μm or less may also be used. In view of thinning, the thickness is preferably from 1 to 7 μm. Such a thin polarizer is less uneven in thickness, has good visibility, and is less dimensionally-variable and therefore has high durability. It is also preferred because it can form a thinner polarizing film.

Typical examples of such a thin polarizer include the thin polarizing layers disclosed in JP-A No. 51-069644, JP-A No. 2000-338329, the pamphlet of WO2010/100917, the specification of PCT/JP2010/001460, the specification of Japanese Patent Application No. 2010-269002, or the specification of Japanese Patent Application No. 2010-263692. These thin polarizing layers can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage, which would otherwise be caused by stretching of the layer supported on a stretchable resin substrate.

Among processes including the steps of stretching and dyeing a laminate, a process capable of high-ratio stretching to improve polarizing performance is preferably used to obtain the thin polarizing layer. Therefore, the thin polarizing layer is preferably obtained by a process including the step of stretching in an aqueous boric acid solution as disclosed in the pamphlet of WO2010/100917, the specification of PCT/JP2010/001460, the specification of Japanese Patent Application No. 2010-269002, or the specification of Japanese Patent Application No. 2010-263692, in particular, preferably obtained by a process including the step of performing auxiliary in-air stretching before stretching in an aqueous boric acid solution as disclosed in the specification of Japanese Patent Application No. 2010-269002 or the specification of Japanese Patent Application or 2010-263692.

<Adhesive Layer>

The adhesive layer may be of any type as long as it is optically transparent. Any of various adhesives such as aqueous-type, solvent-type, hot melt-type, and radical-curable type adhesives may be used to form the adhesive layer. For example, a radical-curable adhesive is preferably used to form the adhesive layer. The radical-curable adhesive may be, for example, an active energy ray-curable adhesive such as an electron beam-curable or ultraviolet-curable adhesive. An active energy ray-curable adhesive is preferred because it is curable in a short time. An ultraviolet-curable adhesive is more preferred because it is curable with low energy.

The ultraviolet-curable adhesive can be broadly divided into a radically polymerizable curable adhesive and a cationically polymerizable adhesive. In addition, the radically polymerizable curable adhesive nay be used as a thermosetting adhesive.

Examples of the curable component of the radically polymerizable curable adhesive include (meth)acryloyl group-containing compounds and vinyl group-containing compounds. These curable components may be monofunctional, bifunctional, or polyfunctional. These curable components may be used singly or in combination of two or more. Among these curable components, for example, (meth)acryloyl group-containing compounds are preferred.

Examples of (meth)acryloyl group-containing compounds include methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, sec-butyl (meth)acrylate, tert-butyl (meth)acrylate, n-pentyl (meth)acrylate, tert-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, n-octadecyl (meth)acrylate, and other (meth)acrylic (C1-C20) alkyl esters.

Examples of (meth)acryloyl group-containing compounds also include cycloalkyl (meth)acrylates (e.g., cyclohexyl (meth)acrylate and cyclopentyl (meth)acrylate), aralkyl (meth)acrylates (e.g., benzyl (meth)acrylate), polycyclic (meth)acrylates (e.g., 2-isobornyl (meth)acrylate, 2-norbornylmethyl (meth)acrylate, 5-norbornene-2-yl-methyl (meth)acrylate, and 3-methyl-2-norbornylmethyl (meth)acrylate), hydroxyl group-containing (meth)acrylic esters (e.g., hydroxyethyl (meth)acrylate, 2-hydroxypropyl (meth)acrylate, and 2,3-dihydroxypropylmethyl-butyl (meth)acrylate), alkoxy or phenoxy group-containing (meth)acrylic esters (e.g., 2-methoxyethyl (meth)acrylate, 2-ethoxyethyl (meth)acrylate, 2-methoxymethoxyethyl (meth)acrylate, 3-methoxybutyl (meth)acrylate, ethyl carbitol (meth)acrylate, and phenoxyethyl (meth)acrylate), epoxy group-containing (meth)acrylic esters (e.g., glycidyl (meth)acrylate), halogen-containing (meth)acrylic esters (e.g., 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, and heptadecafluorodecyl (meth)acrylate), and alkylaminoalkyl (meth)acrylates (e.g., dimethylaminoethyl (meth)acrylate).

Besides the above, (meth)acryloyl group-containing compounds include hydroxymethylacrylamide, N-methylolacrylamide, N-methoxymethylacrylamide, N-ethoxymethylacrylamide, (meth)acrylamide, and other amide group-containing monomers. Nitrogen-containing monomers such as acryloylmorpholine may also be used.

The curable component of the radically polymerizable curable adhesive may also be a compound having two or more polymerizable double bonds such as those in (meth)acryloyl groups and vinyl groups. Such a compound may also be added as a crosslinking component to the adhesive component. Examples of such a curable component capable of serving as a crosslinking agent include tripropylene glycol diacrylate, 1,9-nonanediol diacrylate, tricyclodecanedimethanol diacrylate, cyclic trimethylolpropane formal acrylate, dioxane glycol diacrylate, EO-modified diglycerine tetraacrylate, Aronix M-220 (manufactured by Toagosei Co., Ltd.), LIGHT ACRYLATE 1,9ND-A (manufactured by Kyoeisha Chemical Co., Ltd.), LIGHT ACRYLATE DGE-4A (manufactured by Kyoeisha Chemical Co., Ltd.), LIGHT ACRYLATE DCP-A (manufactured by Kyoeisha Chemical Co., Ltd.), SR-531 (manufactured by Sartomer), and CD-536 (manufactured by Sartomer). If necessary, a variety of epoxy (meth)acrylates, urethane (meth)acrylates, polyester (meth)acrylates, and (meth)acrylate monomers may also be used.

To form the radically polymerizable curable adhesive, a radical polymerization initiator may be added, depending on the curing type, to the curable component. When the adhesive is for use as an electron beam curable adhesive, it does not always have to contain a radical polymerization initiator. On the other hand, a radical polymerization initiator is used for an ultraviolet-curable or thermosetting adhesive. The radical polymerization initiator is generally used in an amount of about 0.1 to about 10 parts by weight, preferably 0.5 to 3 parts by weight, based on 100 parts by weight of the curable component. If necessary, the radically polymerizable curable adhesive may also contain a photosensitizer capable of increasing electron beam-curing rate and sensitivity, such as a carbonyl compound. The photosensitizer is generally used in an amount of about 0.001 to about 10 parts by weight, preferably 0.01 to 3 parts by weight, based on 100 parts by weigh of the curable component.

The curable component of the cationically polymerizable curable adhesive may be an epoxy or oxetanyl group-containing compound. The epoxy group-containing compound may be any compound having at least two epoxy groups per molecule. A variety of generally known curable epoxy compounds may be used. Preferred epoxy compounds are, for example, compounds having at least two epoxy groups and at least one aromatic ring per molecule or compounds having at least two epoxy groups per molecule, in which at least one of them is formed between two adjacent carbon atoms that form an alicyclic ring.

To form the adhesive layer, an aqueous curable adhesive may be used such as a vinyl polymer-based, gelatin-based, vinyl-based, latex-based, polyurethane-based, isocyanate-based, polyester-based, or epoxy-based adhesive. When such an aqueous adhesive is used, the adhesive layer can be formed as a dried coating layer from an aqueous solution. When such an aqueous solution is prepared, if necessary, a crosslinking agent, other additives, and a catalyst such as an acid may also be added to the aqueous solution.

The aqueous adhesive is preferably a vinyl polymer-containing adhesive or the like. The vinyl polymer is preferably a polyvinyl alcohol resin. The polyvinyl alcohol resin more preferably has an acetoacetyl group, so that it can form an adhesive with improved durability. A crosslinking agent may be added to the polyvinyl alcohol resin. Such a crosslinking agent is preferably a compound having at least two functional groups reactive with the polyvinyl alcohol resin. Examples of the cross linking agent include boric acid, borax, carboxylic acid compounds, alkyldiamines, isocyanates, epoxy compounds, monoaldehydes, dialdehydes, amino-formaldehyde resins, and salts and oxides of bivalent or trivalent metals. A water-soluble silicate may be added to the polyvinyl alcohol resin. The water-soluble silicate may be lithium silicate, sodium silicate, potassium silicate, or the like.

If necessary, the adhesive used to form the adhesive layer may also contain suitable adhesives. Examples of such additives include coupling agents such as silane coupling agents and titanium coupling agents, adhesion promoters such as ethylene oxide, additives for improving wettability to the transparent film, additives for improving mechanical strength or workability, such as acryloxy group-containing compounds and hydrocarbon-based materials (natural and synthetic resins), ultraviolet absorbers, age resisters, dyes, processing aids, ion trapping agents, antioxidants, tackifiers, fillers (other than metal compound fillers), plasticizers, leveling agents, anti-foaming agents, antistatic agents, and stabilizers such as heat-resistant stabilizers and hydrolysis-resistant stabilizers.

<Method for Manufacturing Polarizing Plate>

The polarizing plate of the invention is manufactured by bonding the modification layer of the polarizer protecting film to a polarizer using the adhesive. In the bonding step of this manufacturing process, the adhesive is applied to the surface of the polarizer, on which the adhesive layer is to be formed, and/or the surface of the modification layer of the transparent protective film, and then, the polarizer and the modification layer of the transparent protective film are bonded together with the adhesive.

Before coated with the adhesive, the polarizer and/or the modification layer of the transparent protective film may be subjected to a surface modifying treatment. Specifically, the treatment may be a corona treatment, a plasma treatment, a saponification treatment, or the like.

The method for applying the adhesive is appropriately selected depending on the viscosity of the adhesive and the desired thickness. Examples of application means include a reverse coater, a gravure coater (direct, reverse, or offset), a bar reverse coater, a roll coater, a die coater, a bar coater, a rod coater, etc. Any other suitable application method such as dipping may also be used.

The thickness of the adhesive layer is preferably, but not limited to, about 10 to about 300 nm after it is dried. In order to obtain uniform in-plane thickness and sufficient adhering strength, the thickness of the adhesive layer is more preferably 10 to 200 nm, even more preferably 20 to 150 nm.

The polarizer and the transparent protective film are bonded together with the adhesive applied as described above. A roll laminator or other means may be used to bond the polarizer and the transparent protective film.

After the polarizer and the transparent protective film are bonded together, the adhesive is cured optionally depending on the type of the adhesive, so that an adhesive layer is formed. For example, when an active energy ray-curable adhesive is used, the step of applying active energy rays is performed, and when an aqueous adhesive is used, the step of drying is performed.

A polarizing plate of the invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

The optical film including a laminate of the polarizing plate and the optical layer may be formed by a method of stacking them one by one in the process of manufacturing a liquid crystal display device or the like. However, an optical film formed in advance by lamination is advantageous in that it can facilitate the process of manufacturing a liquid crystal display device or the like because it has stable quality and good assembling workability. In the lamination, any appropriate bonding means such as a pressure-sensitive adhesive layer may be used. When the polarizing plate and any other optical layer are bonded together, their optical axes may be each aligned at an appropriate angle, depending on the desired retardation properties or other desired properties.

The polarizing plate or the optical film including at least one layer of the polarizing plate may be provided with a pressure-sensitive adhesive layer for boding to any other member such as a liquid crystal cell. The pressure-sensitive adhesive used to form the pressure-sensitive adhesive layer may be of any type, which is, for example, selected as appropriate from pressure-sensitive adhesives including, as abase polymer, an acryl-based polymer, a silicone-based polymer, polyester, polyurethane, polyamide, polyether, a fluoropolymer, or a rubber polymer. In particular, pressure-sensitive adhesives having a high level of optical transparency, weather resistance, and heat resistance and a suitable level of wettability and adhesive properties such as cohesion and adhesion are preferably used, such as acrylic pressure-sensitive adhesives.

The pressure-sensitive adhesive layer or layers may be formed on one or both sides of the polarizing plate or the optical film by any suitable method. For example, such a method may include dissolving or dispersing a base polymer or a composition thereof in a suitable single solvent such as toluene or ethyl acetate or a mixture thereof to prepare an about 10 to 40% by weight pressure-sensitive adhesive solution and directly applying the solution to the polarizing plate or the optical film by any suitable spreading method such as casting or coating, or may include forming a pressure-sensitive adhesive layer on a separator similarly to the above method and transferring it onto the polarizing plate or the optical film.

The pressure-sensitive adhesive layer may also be formed as a laminate of layers different in composition, type or other properties on one or both sides of the polarizing plate or the optical film. When pressure-sensitive adhesive layers are provided on both sides, they may be different in composition, type, thickness, or other properties between the front and back sides of the polarizing plate or the optical film. The thickness of the pressure-sensitive adhesive layer is generally from 1 to 500 μm, preferably from 5 to 200 μm, more preferably from 10 to 100 μm, and it may be appropriately determined depending on the purpose of use, adhering strength, or other factors.

The exposed surface of the pressure-sensitive adhesive layer may be temporarily covered with a separator for anti-pollution or other purposes until it is actually used. This can prevent contact with the pressure-sensitive adhesive layer during usual handling. According to conventional techniques, except for the above thickness conditions, a suitable separator may be used, such as a plastic film, a rubber sheet, a paper sheet, a cloth, a nonwoven fabric, a net, a foam sheet, a metal foil, any laminate thereof, or any other suitable thin material, which is optionally coated with any suitable release agent such as a silicone, long-chain alkyl, or fluoride release agent, or molybdenum sulfide.

In the invention, the ability to absorb ultraviolet rays may be imparted to the polarizer, the transparent protective film, or the optical film used to form the polarizing plate, or to each layer such as the pressure-sensitive adhesive layer, for example, by a treatment with an ultraviolet absorber such as a salicylic ester compound, a benzophenol compound, a benztriazole compound, a cyanoacrylate compound, or a nickel complex salt compound.

The polarizing plate or optical film of the invention is preferably used to form liquid crystal display devices or other various devices. Liquid crystal display devices may be formed according to conventional techniques. Specifically, a liquid crystal display device may be typically formed by appropriately assembling a liquid crystal cell, polarizing plates or optical films, and an optional component such as a lighting system, and incorporating a driving circuit according to any conventional techniques, except that the polarizing plates or optical films used are according to the invention. The liquid crystal cell to be used may also be of any type such as TN type, STN type, or n type.

Any desired liquid crystal display device may be formed, such as a liquid crystal display device including a liquid crystal cell and the polarizing plate or plates or the optical film or films placed on one or both sides of the liquid crystal cell or a liquid crystal display device further including a backlight or a reflector in a lighting system. In such a case, the polarizing plate or plates or the optical film or films according to the invention may be placed on one or both sides of the liquid crystal cell. When the polarizing plates or the optical films are provided on both sides, they may be the same or different. The process of forming a liquid crystal display device may also include placing a suitable component such as a diffusion plate, an antiglare layer, an anti-reflection film, a protective plate, a prism array, a lens array sheet, a light diffusion plate, or a backlight in one or more layers at a suitable position or positions.

### EXAMPLES

Hereinafter, the invention will be further described with reference to examples and comparative examples. It will be understood that these examples are not intended to limit the invention.

<Preparation of Polarizer>

A 30-μm-thick polyvinyl alcohol film with a degree of polymerization of 2, 400 and a degree of saponification of 99.9% was uniaxially stretched to 2.0 times its original length while it was allowed to swell by being immersed in warm water at 30° C. The polyvinyl alcohol film was then dyed by being immersed in an aqueous solution (dyeing bath) containing 0.3% by weight of a mixture of iodine and potassium iodide (0.5:8 in weight ratio) while it was uniaxially stretched to 3.0 times its original length. The polyvinyl alcohol film was then stretched to 3.7 times its original length while it was immersed in an aqueous solution (crosslinking bath 1) of 5% by weight of boric acid and 3% by weight of potassium iodide. The polyvinyl alcohol film was then stretched to 6 times its original length in an aqueous solution (crosslinking bath 2) of 4% by weight of boric acid and 5% by weight of potassium iodide at 60° C. Subsequently, the polyvinyl alcohol film was impregnated with iodide ions in an aqueous solution of 3% by weight of potassium iodide (iodine impregnation bath) and then dried in an oven at 60° C. for 4 minutes to give a polarizer. The resulting polarizer had a thickness of 12 μm.

<Thermoplastic Resin Film>

COP: ZEONOR (trade name) manufactured by Zeon Corporation was used. It has a thickness of 25 μm, an in-plane retardation of 116 nm, and a thickness direction retardation of 37 nm.

Norbornene: ARTON (trade name) manufactured by JSR Corporation was used. It has a thickness of 25 μm, an in-plane retardation of 116 nm, and a thickness direction retardation of 137 nm.

Acryl: A lactonized polymethyl methacrylate film (20% in degree of lactonization) was used. It has a thickness of 15 μm, an in-plane retardation of at most 40 nm, and a thickness direction retardation of at most 20 nm.

<Preparation of Aqueous Adhesive>

An acetoacetyl group-containing polyvinyl alcohol resin (1,200 in average degree of polymerization, 98.5% by mole in degree of saponification, 5% by mole in degree of acetoacetylation) was dissolved in pure water under 30° C. temperature conditions so that an aqueous adhesive with an adjusted solid concentration of 4% was obtained.

### Example 1

### Formation of Modification Layer

A mixed solvent was prepared by mixing cyclopentyl methyl ether (CPME) and acetone in a ratio of 30:70 (volume ratio). After the surface of the thermoplastic resin film (COP) was corona-treated, the mixed solvent was applied to the film with a wire bar. The coated film was dried at 30° C. for 2 minutes to give a polarizer protecting film with a 320-nm-thick modification layer on its surface.

(Preparation of Polarizing Plate)

The aqueous adhesive was applied to one side of the polarizer protecting film with the modification layer (specifically, applied to the surface of the modification layer) in such a way that an 80-nm-thick adhesive layer would be formed after drying. In this way, adhesive-bearing, polarizer-protecting films were obtained. Subsequently, the adhesive-bearing, polarizer-protecting films were bonded to both sides of the polarizer with a roller machine under 23° C. temperature conditions. The resulting laminate was then dried at 55° C. for 6 minutes to give a polarizing plate. The polarizer and the adhesive-bearing, polarizer-protecting films were bonded in such a way that the adhesive layer of each polarizer-protecting film was brought into contact with the polarizer.

### Examples 2 to 9 and Comparative Examples 1 to 7

Modification layer-bearing, polarizer-protecting films and polarizing plates were obtained as in Example 1, except that the type of the thermoplastic resin film and the type or mixing ratio of the solvents used to form the modification layer were changed as shown in Table 1.

[Evaluation]

The modification layer-bearing, polarizer-protecting films and the polarizing plates obtained in the examples and the comparative examples were evaluated as described below. Table 1 shows the results.

<Thickness of Modification Layer>

The thickness of the modification layer of each resulting polarizer protecting film was determined from the difference in contrast observed in a TEM image.

<Haze>

The haze (external haze) of each resulting polarizer protecting film was measured with a haze meter (HGM-20P manufactured by Suga Test Instruments Co., Ltd.) according to JIS K 7136.

<Method for Measuring Peel Strength>

Each resulting polarizing plate was measured for peel strength by the method described below. Note that the peel strength is preferably 1 N or more, more preferably 1.5 N or more.

The polarizing plate was cut into a piece with a length of 200 mm in a direction parallel to the stretched direction of the polarizer and with a width of 15 mm in a direction perpendicular thereto. Using a cutter knife, an incision was made between the thermoplastic resin film and the polarizer, and then the polarizing plate was bonded to a glass plate. The protective film was peeled off from the polarizer at an angle of 90° and a peel rate of 3,000 mm/minute when the peel strength was measured with a Tensilon tester. After the polarizing plate of Comparative Example 2 was subjected to the peeling, the surface exposed by the peeling was subjected to infrared absorption spectrum measurement by ATR method. The measurement showed that the thermoplastic resin film underwent cohesive failure (rapture of the film).

<Uneven Coating>

Whether or not uneven coating occurred on each resulting polarizing plate was evaluated by visual observation.

TABLE 1

| | | Solvent (A) | | | Polarizer protecting film | | Evaluations | |
|---|---|---|---|---|---|---|---|---|
| | Thermoplastic | Modification | Solvent | (a):(b) | Modification layer | | | Uneven |
| | resin film type | solvent (a) | (b) | ratio | thickness (nm) | Haze (%) | Peel strength (N) | coating |
| Example 1 | COP | CPME | Acetone | 30:70 | 320 | 3.0 | 3.0 | Absent |
| Example 2 | COP | CPME | IPA | 40:60 | 280 | 3.0 | 1.3 | Absent |
| Example 3 | COP | CPME | MEK | 35:65 | 350 | 4.0 | 1.5 | Absent |
| Example 4 | COP | Cyclopentanol | Acetone | 30:70 | 300 | 2.5 | 2.8 | Absent |
| Example 5 | Norbornene | CPME | Acetone | 10:90 | 200 | 6.5 | 1.0 | Absent |
| Example 6 | Acryl | Cyclohexanol | IPA | 20:80 | 150 | 2.3 | 1.8 | Absent |
| Example 7 | COP | CPME | Acetone | 25:75 | 240 | 1.5 | 2.1 | Absent |
| Example 8 | COP | CPME | Acetone | 20:80 | 180 | 1.0 | 1.5 | Absent |
| Example 9 | COP | CPME | Acetone | 15:85 | 100 | 0.7 | 1.0 | Absent |
| Comparative | COP | CPME | Acetone | 8:92 | 45 | 0.1 | 0.5 | Absent |
| Example 1 | | | | | | | | |
| Comparative | COP | CPME | Acetone | 55:45 | 800 | 23.0 | Film rapture | Absent |
| Example 2 | | | | | | | (3 N or more) | |
| Comparative | COP | THF | Acetone | 20:80 | 10 | 0.1 | 0.4 | Absent |
| Example 3 | | | | | | | | |
| Comparative | COP | Toluene | MEK | 20:80 | 270 | 4.9 | 1.9 | Present |
| Example 4 | | | | | | | | |
| Comparative | Norbornene | Toluene | IPA | 10:90 | 100 | 2.8 | 1.0 | Present |
| Example 5 | | | | | | | | |
| Comparative | Acryl | Toluene | Ethyl | 10:90 | 150 | 1.8 | 1.5 | Present |
| Example 6 | | | acetate | | | | | |
| Comparative | COP | Cyclopentanol | Acetone | 5:95 | 45 | 0.3 | 0.5 | Absent |
| Example 7 | | | | | | | | |

In Table 1, CPME represents cyclopentyl methyl ether, IPA isopropyl alcohol, MEK methyl ethyl ketone, and THF tetrahydrofuran.

1. A polarizer protecting film, comprising:
a transparent thermoplastic resin film; and
a modification layer that is provided on one or both sides of the transparent thermoplastic resin film and comprise at least one modification solvent (a) selected from an alicyclic ether and an alicyclic alcohol,
the polarizer protecting film having a haze of 0.5% to 7%.

2. The polarizer protecting film according to claim 1, wherein the transparent thermoplastic resin film comprises at least one resin selected from a cyclic polyolefin resin and a (meth)acrylic resin.

3. The polarizer protecting film according to claim 1, wherein the modification layer has a thickness of 50 nm to 600 nm.

4. The polarizer protecting film according to claim 1, which has a thickness of 5 μm to 100 μm.

5. The polarizer protecting film according to claim 1, wherein the transparent thermoplastic resin film is a retardation film.

6. A method for producing the polarizer protecting film according to claim 1, wherein the method comprises subjecting one or both sides of a transparent thermoplastic resin film to a surface treatment by bringing a solvent (A) into contact with one or both sides of the transparent thermoplastic resin film to form a modification layer on one or both sides, wherein the solvent (A) comprises at least one modification solvent (a) selected from an alicyclic ether and an alicyclic alcohol.

7. The method according to claim 6, wherein the solvent (A) contains a solvent (b) that is mixed with the modification solvent (a) and has substantially no effect on the transparent thermoplastic resin film.

8. The method according to claim 7, wherein the ratio of the modification solvent (a) to the solvent (b) is 10:90 to 50:50 by volume.

9. A polarizing plate comprising:
a polarizer;
an adhesive layer; and
the polarizer protecting film according to claim 1 provided on at least one surface of the polarizer with the adhesive layer interposed therebetween, wherein the adhesive layer is in contact with the modification layer of the polarizer protecting film.

10. An optical film comprising the polarizing plate according to claim 9.

11. An image display device comprising the polarizing plate according to claim 9.

12. An optical film comprising the polarizing plate according to claim 10.
